(19) United States
(12) Patent Application Publication
(10) Pub. No.: US 2002/0030086 A1
(43) Pub. Date: Mar. 14, 2002

(54) Pitch and roll mechanism for a flip chip bonding machine

(76) Inventors: Steven M. Solon, Mechanicsburg, PA (US); David Leggett, Killington, VT (US)

Correspondence Address: Royal W. Craig, Law Offices of Royal W. Craig, Suite 1319, 210 N. Charles Street, Baltimore, MD, 21201, US

(21) Appl. No.: 09/848,880

(22) Filed: May 4, 2001

Related U.S. Application Data
(60) Provisional application No. 60/201,998, filed on May 4, 2000.

(51) Int. Cl. B23K 37/00; B23K 1/14; B23K 37/04

(52) U.S. Cl. 228/179.1; 228/47.1; 228/49.1; 414/749.1

(57) ABSTRACT

An improved pitch and roll mechanism is disclosed herein which provides for increased flexibility, stability, and accuracy of motion in positioning a miniaturized electronic component in a flip chip bonding system. The pitch and roll mechanism generally includes a pitch axis assembly comprising a plurality of bearing surfaces, each possessing a circular curvature, and at least one roller bearing in operative contact with at least one of the aforementioned pitch axis bearing surfaces. In addition, a roll axis assembly, mounted at a right angle, or perpendicularly, to the pitch axis assembly, is provided. The roll axis assembly typically includes a plurality of bearing surfaces, each possessing a circular curvature, and at least one roller bearing in operative contact with at least one of the aforementioned roll axis bearing surfaces. The curvatures of the pitch and roll axis bearing surfaces are such that a single, coincident center of rotation for both the pitch and roll axis assemblies is created.

### CROSS-REFERENCE TO RELATED APPLICATIONS

The present application derives priority from U.S. Provisional Patent Application No. 60/201,998 for “PITCH AND ROLL ASSEMBLY FOR A FLIP CHIP BONDING MACHINE” filed May 4, 2000.

### BACKGROUND OF THE INVENTION

1. Field of the Invention

The present invention relates to flip chip bonding systems for automatically positioning and bonding miniaturized electronic components (i.e. multi-chip modules, flip chips, optoelectronic components, and other bonded assemblies), and in particular, to an improved pitch and roll mechanism used to position the workpieces in the bonding head assembly.

2. Description of the Background

A “flip chip” bonding system is a computer-controlled system for automatically positioning and bonding a variety of miniaturized electronic components, and in particular, flip chips. Flip chip bonding systems typically utilize articulated bonding heads to position the workpieces. Stability, accuracy, and flexibility are paramount considerations in the design of such bonding heads. Most bonding heads are designed for movement along X- and Y-axes in accordance with a linear coordinate table (i.e. axial motion). An example of prior art utilizing linear coordinate table movement is U.S. Pat. No. 6,182,355 to Zach. However, designs based solely on axial motion sacrifice flexibility of motion. Others have improved on this basic concept by introducing arcuate motion. U.S. Pat. No. 5,556,022 to Orcutt et al. discloses a polar motion bonding head, for use in positioning and bonding semiconductor devices, that replaces the axial motion of a typical X/Y-axis coordinate table with that of a polar coordinate table. This particular design, however, sacrifices stability. Still others have added some degree of adjustment for the angle of inclination of the workpiece. U.S. Pat. No. 4,899,921 to Bendat et al. discloses an apparatus that provides for angular workpiece adjustment in addition to motion along the X-, Y-, and Z-axes.

While the means to create the required axial motion are well known in the art, the present inventors are unaware of any apparatus that uses roller bearings to provide the precise angular adjustment required to establish absolute parallelism between the miniaturized electronic components that are to be bonded. Additionally, as discussed above, this must be accomplished without sacrificing stability, accuracy, and flexibility. Therefore, it would be greatly advantageous to provide a bonding head assembly that, in addition to the standard, multi-axis linear motion capabilities, possesses the requisite degree of pitch and roll functionality (i.e. rotational motion centered on the X- and Y-axes, respectively). Once bonding head assemblies are equipped with improved pitch and roll capabilities, component assembly errors, and the resulting operational malfunctions, due to planar misalignment at the moment of bonding will be greatly reduced.

### SUMMARY OF THE INVENTION

It is, therefore, the primary object of the present invention to provide an improved pitch and roll mechanism for use in flip chip bonding systems that increases the range of motion of the workpiece contained therein without sacrificing stability, accuracy, and flexibility.

It is another object to provide an improved pitch and roll mechanism that provides rotational workpiece motion around two, perpendicular axes (i.e. X- and Y-axes, or pitch and roll axes) of motion.

It is a further object to provide an improved pitch and roll mechanism that provides two-axis, rotational workpiece motion utilizing a concept incorporating two primary sub-assemblies (i.e. the pitch axis assembly and the roll axis assembly), where the two sub-assemblies operate both independently of each other and in coordination with each other.

It is another object to provide an improved pitch and roll mechanism that provides a single, coincident center of rotation for both the pitch axis assembly and the roll axis assembly.

It is still another object to provide an improved pitch and roll mechanism that provides for the linking of a variety of drive means to either the pitch axis assembly or the roll axis assembly.

It is a further object of the present invention to provide an economical design for an improved pitch and roll mechanism that utilizes existing, commercially available components and established machining practices to the extent possible.

In accordance with the above-described and other objects, an improved pitch and roll mechanism is disclosed which provides for increased flexibility, stability, and accuracy of motion in positioning a workpiece in a flip chip bonding system. The pitch and roll mechanism generally includes a pitch axis assembly including a first pitch axis sub-assembly in operative engagement with a second pitch axis sub-assembly, the two sub-assemblies being adapted for relative translational movement such that rotational movement only of the component/workpiece is generated. In addition, the pitch and roll mechanism includes a roll axis assembly having a first roll axis sub-assembly in operative engagement with a second roll axis sub-assembly, these two sub-assemblies being adapted for relative translational movement such that rotational movement only of the component/workpiece is generated, wherein the axis of rotation is orthogonal to that of the pitch axis assembly.

In one embodiment, the pitch axis assembly includes one pitch axis sub-assembly comprising a plurality of bearing surfaces, each possessing a circular curvature, and a second cooperating sub-assembly having at least one roller bearing in operative contact with at least one of the aforementioned pitch axis bearing surfaces. The opposing pitch axis sub-assemblies are adapted for translational movement relative to each other such that rotational movement only of a component/workpiece is generated. In addition, the roll axis assembly is mounted at a right angle, or perpendicularly, to the pitch axis assembly. The roll axis assembly likewise includes a first sub-assembly having a plurality of bearing surfaces, each possessing a circular curvature, and a cooperating second sub-assembly having at least one roller bearing in operative contact with at least one of the aforementioned roll axis bearing surfaces. Again, the opposing roll axis sub-assemblies are adapted for translational movement relative to each other such that rotational movement only of a component/workpiece is generated. The curvatures of the respective pitch and roll axis bearing surfaces are such that the pitch axis defines an axis of rotation, the roll axis defines an orthogonal axis of rotation, and the respective pitch and roll axes of rotation intersect at a single coincident point which is defined as a single, coincident center of rotation for both the pitch and roll axis assemblies is created.

An alternative embodiment is shown in which a plurality of radial slide assemblies are used instead of discrete roller bearings and bearing surfaces.

In either case, the pitch and roll assemblies may each be equipped with an independent drive mechanism (i.e. the combination of a lead screw assembly and a lead screw pivot assembly) that provides a connecting means for any one of a variety of drive devices incorporated within a flip chip bonding system. The improved pitch and roll mechanism is economical as it can be reduced to practice using many commercially available components (e.g. roller bearings, springs), conventional raw materials (e.g. aluminum, brass, stainless steel), and by established machining practices (i.e. to convert the raw materials into finished parts).

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of the improved pitch and roll mechanism 100 according to a first embodiment of the present invention.

FIG. 2 is a partially exploded perspective view of the improved pitch and roll mechanism 100 according to a first embodiment of the present invention where the pitch axis assembly 12 is shown separated from the roll axis assembly 15.

FIG. 3 is a bottom perspective view of the pitch axis carriage assembly 40 of the improved pitch and roll mechanism according to a first embodiment of the present invention.

FIG. 4 is a partially exploded bottom perspective view of the roll axis assembly 15 of the improved pitch and roll mechanism according to a first embodiment of the present invention.

FIG. 5 is a bottom perspective view of the roll axis carriage assembly 80 of the improved pitch and roll mechanism according to a first embodiment of the present invention.

FIG. 6a is a bottom perspective view of the pitch and roll axis drive mechanisms 120, 130, respectively, of the improved pitch and roll mechanism according to a first embodiment of the present invention.

FIG. 6b is an exploded side perspective view of the lead screw assembly 140 of the improved pitch and roll mechanism according to a first embodiment of the present invention.

FIG. 6c is an exploded top perspective view of the lead screw pivot assembly 160 of the improved pitch and roll mechanism according to a first embodiment of the present invention.

FIGS. 7a-d are side perspective views of the improved pitch and roll mechanism 100 according to a first embodiment of the present invention.

FIG. 8 is a side perspective view of the tension spring assembly 24 of the improved pitch and roll mechanism according to a first embodiment of the present invention.

FIG. 9 is a perspective view of the pitch and roll mechanism 101 according to an alternative embodiment of the present invention.

FIG. 10 is an exploded perspective view of the pitch and roll mechanism 101 of FIG. 9 wherein the mechanism 101 has been rotated 90° counterclockwise (as viewed from above).

### DETAILED DESCRIPTION OF THE PREFERRED EMBODIMENTS

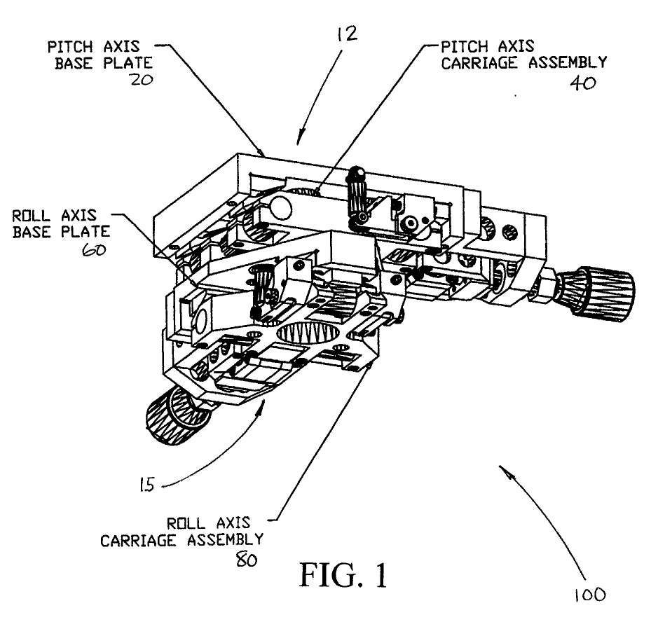

FIG. 1 is a perspective view of the improved pitch and roll mechanism 100 according to a first embodiment of the present invention. The pitch and roll mechanism 100 adjusts the angular orientation of two discrete workpieces prior to assembly and bonding (for example two layers of a multi-layer chip). More specifically, it adjusts the angular position of the mating surface of the integrated circuit wafer or chip so that it is parallel along two horizontal axes with the mating surface of the patterned substrate. In other words, the pitch and roll mechanism 100 allows adjustment of the angular position such that the planes of the two mating surfaces are parallel.

The pitch and roll mechanism 100 includes two distinct major assemblies that are labeled in FIG. 1: a pitch axis assembly 12; and roll axis assembly 15. These two assemblies work together in the flip chip bonding system to adjust the angular position of the workpiece along the two horizontal axes.

Generally, the pitch axis assembly 12 includes a first pitch axis sub-assembly in operative engagement with a second pitch axis sub-assembly, the two sub-assemblies being adapted for relative translational-rotational movement as described above. Likewise, the roll axis assembly 15 includes a first roll axis sub-assembly in operative engagement with a second roll axis sub-assembly, these two sub-assemblies being adapted for relative translational-rotational movement, the rotation being orthogonal to that of the pitch axis assembly 12.

With specific regard to the embodiment shown in FIG. 1, the pitch axis assembly 12 further comprises two sub-assemblies including a pitch axis base plate 20 and pitch carriage assembly 40.

The roll axis assembly 15 further comprises two sub-assemblies including a roll axis base plate 60 and the roll axis carriage assembly 80.

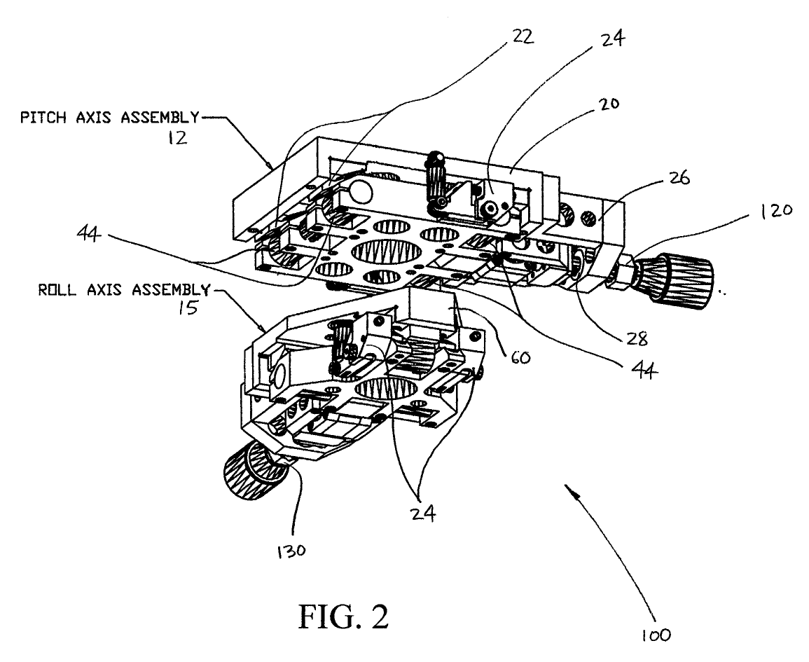

FIG. 2 is partially exploded perspective view of the pitch and roll mechanism 100 according to the present invention which shows separation of the pitch axis assembly 12 (inclusive of the pitch axis base plate 20 and the pitch carriage assembly 40) and the roll axis assembly 15 (inclusive of the roll axis base plate 60 and the roll axis carriage assembly 80).

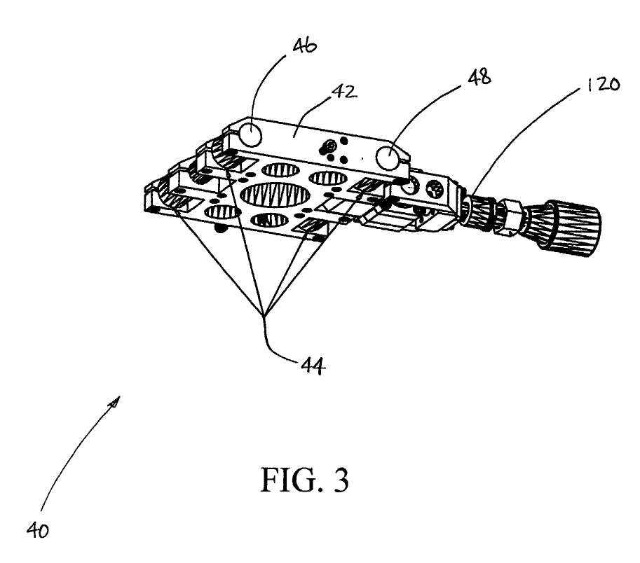

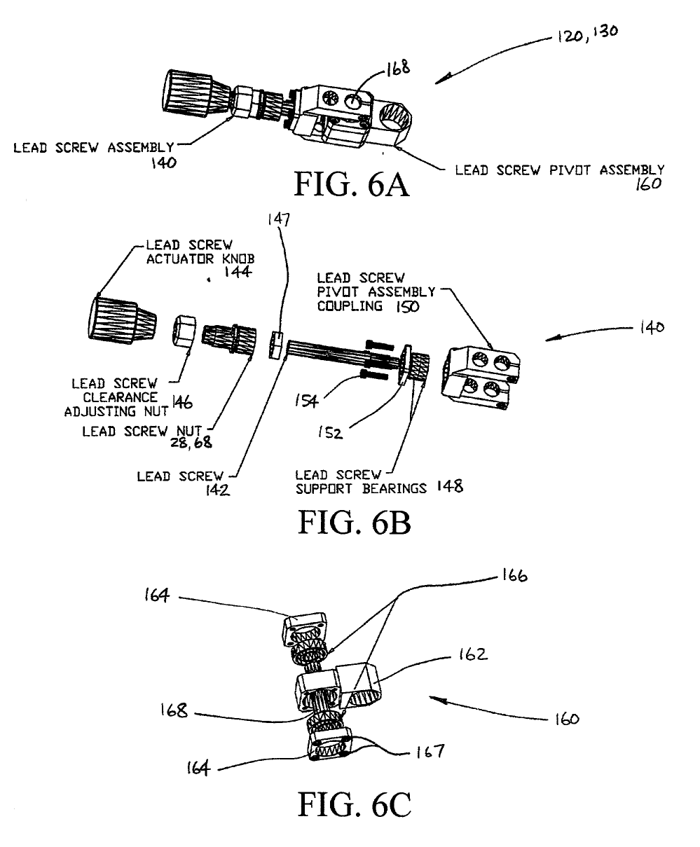

FIG. 3 is a bottom perspective view of the pitch axis carriage assembly 40 as seen in FIG. 2. The pitch axis carriage assembly 40 further includes a pitch block 42 fabricated of aluminum, tool steel or the like, a plurality of commercially available pitch axis roller bearings 44, a front roller bearing shaft 46 for rotational mounting of all forward pitch axis roller bearings 44, a rear roller bearing shaft 48 for rotational mounting of all rearward pitch axis roller bearings 44, and a pitch axis drive mechanism 120. The two roller bearing shafts 46, 48 are preferably cylindrical rods of precision ground stainless steel which extend through the roller bearings 44 to hold them in the proper position relative to the pitch block 42. The rear shaft 48 also extends through the lead screw pivot assembly 160 (see FIG. 6a), thereby creating a connection between the pitch axis drive mechanism 120 and the pitch block 42 that permits a degree of relative rotational motion between the pitch axis drive mechanism 120 and the block 42 while preventing any linear relative motion.

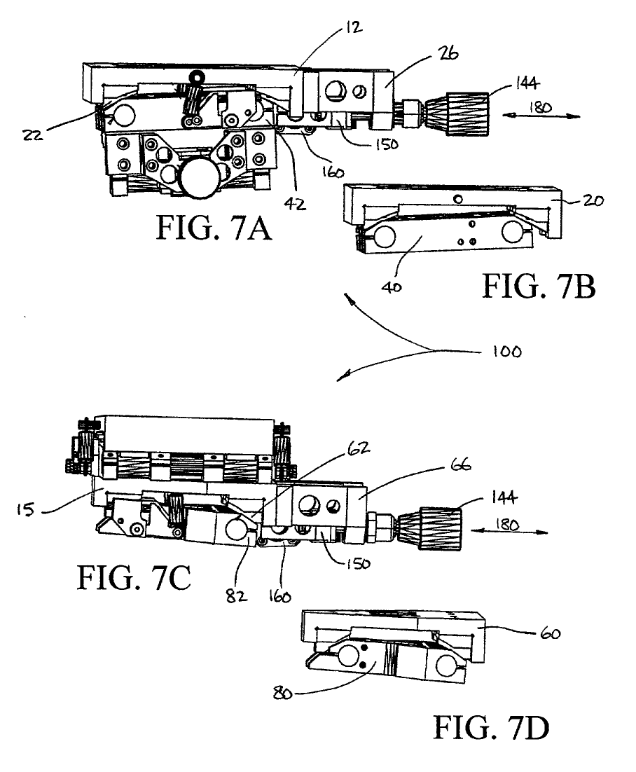

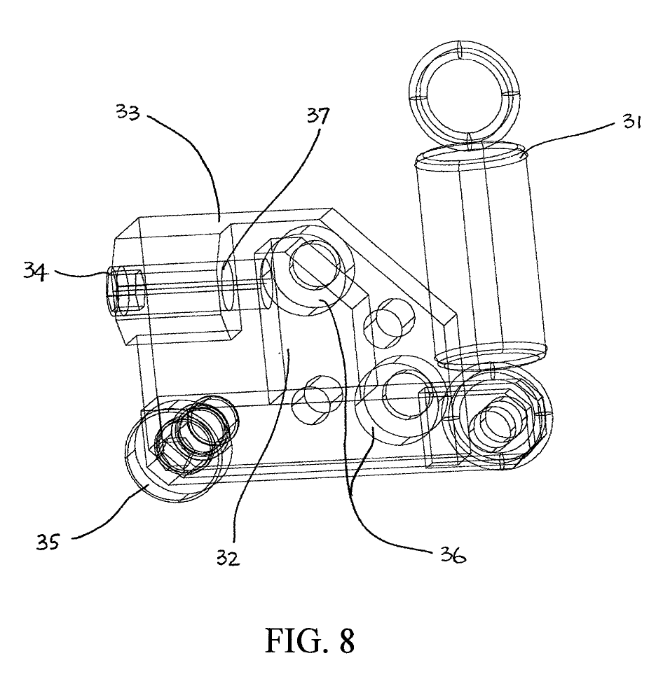

Referring back to FIG. 2, the pitch axis base plate 20 is fabricated of aluminum, tool steel or the like, and is attached to the drive mechanism 120 via a threaded lead screw nut 28 fixedly mounted in a support block 26 (also preferably fabricated of aluminum). A plurality of pitch axis bearing surfaces 22 are also fixedly attached to the base plate 20. The pitch axis bearing surfaces 22 are preferably fabricated as blocks (bronze, cast iron or steel, or other suitable bearing materials) that direct identical concave curved surfaces toward the plurality of pitch axis roller bearings 44, thereby providing individual bearing surfaces for each pitch axis roller bearing 44 when the drive mechanism 120 is rotated. Proper contact between the pitch axis roller bearings 44 and the pitch axis bearing surfaces 22 is maintained by tension spring assemblies 24 (described in detail below with respect to FIG. 8) positioned on both sides of the pitch axis assembly 12. As the pitch axis roller bearings 44 move along the pitch axis bearing surfaces 22, the pitch axis carriage assembly 40 moves through an arc (described in more detail below with respect to FIGS. 7a-b). The center of that arc is herein referred to as the center of rotation of the pitch axis carriage assembly 40.

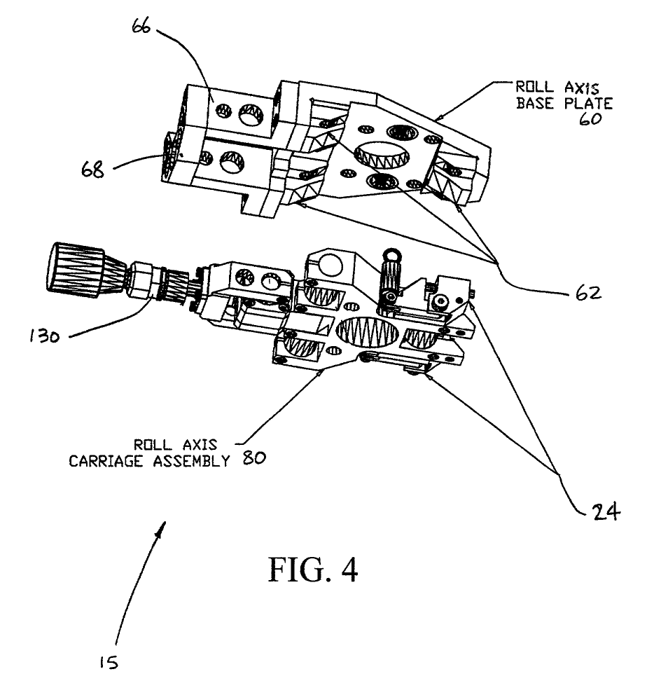

FIG. 4 is a partially exploded bottom perspective view of the roll axis assembly 15 as in FIGS. 1 and 2 (inclusive of the roll axis base plate 60 and the roll axis carriage assembly 80).

The roll axis base plate 60 is preferably fabricated of aluminum, tool steel or the like, and is attached to the roll axis drive mechanism 130 via a threaded lead screw nut 68 fixedly mounted in a support block 66 (support block 66 may also be fabricated of aluminum). A plurality of roll axis bearing surfaces 62 are also fixedly attached to the base plate 60. The roll axis bearing surfaces 62 are, like those of the pitch axis bearing surfaces 22 (see FIG. 2), preferably fabricated of brass or the like and possess identical circular curvatures which are traversed by the plurality of roll axis roller bearings 84 when the drive mechanism 130 is rotated. Proper contact between the roll axis roller bearings 84 and the roll axis bearing surfaces 62 is maintained by tension spring assemblies 24 positioned on both sides of the roll axis assembly 15. As the roll axis roller bearings 84 move along the roll axis bearing surfaces 62, the roll axis carriage assembly 80 moves through an arc (described in more detail below with respect to FIGS. 117c-d). The center of that arc is herein defined as the center of rotation of the roll axis carriage assembly 80, and it is directly orthogonal to the aforesaid pitch axis of rotation.

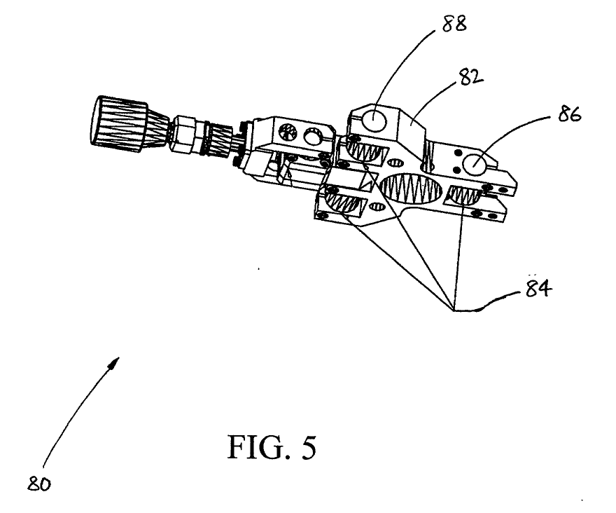

FIG. 5 is a bottom perspective view of roll axis carriage assembly 80. The roll axis carriage assembly 80 includes the roll block 82 preferably fabricated of aluminum or the like, a plurality of commercially available roll axis roller bearings 84, a front roller bearing shaft 86, a rear roller bearing shaft 88, and a roll axis drive mechanism 130. The shafts 86, 88 are preferably formed as precision ground cylindrical stainless steel shafts that extend through the roller bearings 84 to hold them in the proper position relative to the roll block 82. The rear shaft 88 also extends through the lead screw pivot assembly 160 (see FIG. 6a) creating a connection between the roll axis drive mechanism 130 and the roll block 82 that permits a degree of relative rotational motion between the mechanism 130 and the block 82 while preventing any linear relative motion.

FIG. 6a is a bottom perspective view of an exemplary drive mechanism which serves as both pitch and roll axis drive mechanisms 120, 130, respectively. Both pitch and roll axis drive mechanisms 120, 130, respectively, are comprised of a lead screw assembly 140 and a lead screw pivot assembly 160 held together by connecting pin 168. The connection established by pin 168 permits a degree of rotational relative motion between the two assemblies 140, 160 while preventing any linear relative motion.

FIG. 6b is an exploded side perspective view of the lead screw assembly 140 of FIG. 6a. The lead screw assembly 140 is comprised of a lead screw 142, a lead screw actuator knob 144, a lead screw clearance adjusting nut 146, a lead screw locking nut 147, a lead screw nut 28, 68, lead screw support bearings 148, a lead screw pivot assembly coupling 150, a bearing block 152, and a plurality of attachment screws 154. The bearing block 152 is a square bearing preferably fabricated of aluminum and adapted to pass lead screw 142. Commercially available support bearings 148 are slipped onto the appropriate end of the hardened steel lead screw 142, and the assemblage of bearing block 152, bearings 148, and lead screw 142 is fixedly attached to the pivot assembly coupling 150 as shown. Pivot assembly coupling 150 is a yoke and may be fabricated of aluminum. Pivot assembly coupling 150 is threaded from the rear to facilitate attachment to bearing block 152 using a plurality of attachment screws 154.

Knob 144 may be fabricated of molded plastic, aluminum or any other commercially available material suitable for an external connection and turning thereby. Knob 144 is mounted on the distal end of lead screw 142 adjacent an adjusting nut 146, commercially available locking nut 147, and hardened steel lead screw nut 28, 68 (all of which are assembled onto the end of the lead screw 142).

FIG. 6c is an exploded top perspective view of the lead screw pivot assembly 160 of FIGS. 6a and 6b. The lead screw pivot assembly 160 is comprised of a connecting link 162, two bearing blocks 164, two bearings 166, a plurality of attachment screws 167, and a connecting pin 168. The link 162, preferably fabricated of aluminum, and the commercially available bearings 166 are held between, and rigidly fastened together with the two bearing blocks 164, also preferably fabricated of aluminum, by the attachment screws 167. The pin 168, preferably fabricated of precision ground stainless steel, is used to connect the pivot assembly 160 with the lead screw pivot assembly coupling 150.

The entire assemblage of pitch and roll axis drive mechanisms 120, 130 (inclusive of knob 144, adjusting nut 146, locking nut 147, and lead screw nut 28, 68) is then mounted in the respective support blocks 26, 66 (as shown in FIGS. 2 and 4), with lead screw nut 28, 68 held captive therein.

FIGS. 7a-d are side perspective views of the improved pitch and roll mechanism according to a first embodiment of the present invention. Specifically, FIG. 7a shows the pitch axis assembly 12 rotated 3° from its center, or neutral, position. FIG. 7b is a close up view of the pitch axis base plate 20 and the pitch axis carriage assembly 40 of FIG. 7a showing the same degree of rotation. FIG. 7c shows the roll axis assembly 15 rotated 3° from its center position. FIG. 7d is a close up view of the roll axis base plate 60 and the roll axis carriage assembly 80 of FIG. 7c showing the same degree of rotation.

Operation of either the pitch axis assembly 12 or the roll axis assembly 15 is generated by turning the respective lead screw actuator knob 144. It is through an external connection to this knob 144, or some variant design thereof, that the ability to link a variety of drive means to either the pitch axis assembly 12 or the roll axis assembly 15 is provided. The rigid connection between the knob 144 and the lead screw 142 (see FIG. 6b) causes the screw 142 to rotate. Rotation of the screw 142 within the lead screw nut 28, 68 (see FIGS. 2 and 4), fixedly mounted in the support block 26, 66, respectively, causes the screw 142 to move slightly along the line of direction arrow 180. Due to a series of direct connections, this causes corresponding movement of the lead screw pivot assembly coupling 150, the lead screw pivot assembly 160, and the pitch or roll block 42, 82, respectively. Any movement by the block 42, 82 causes the pitch or roll axis roller bearings 44, 84 (see FIGS. 3 and 5), respectively, to traverse the corresponding bearing surfaces 22, 62. Operation of the pitch axis assembly 12 and the roll axis assembly 15 can occur independently or simultaneously.

FIG. 8 is a side perspective view of an exemplary tension spring assembly 24 as in FIG. 2 which assemblies are positioned on both sides of the pitch axis assembly 12 as well as on both sides of the roll axis assembly 15. The tension spring assembly is comprised of a tension spring 31, a spring holder 32 which may be fabricated of stainless steel or the like, a spring tensioning block 33 which may be fabricated of aluminum, steel or the like, an adjustable tension screw 34, a spring holder pivot bolt 35, and two mounting screws 36. The commercially available mounting screws 36 are used to fixedly attach the tensioning block 33 to the pitch block 42, or the roll block 82 (see FIG. 2). The commercially available pivot bolt 35 is used to pivotally attach the spring holder 32 to the tensioning block 33. One end of the tension spring 31 is fixedly attached to the spring holder 32, while the other end is fixedly attached to the pitch axis base plate 20, or the roll axis base plate 60 (see FIG. 2). The commercially available tension screw 34 extends through a threaded hole 37 in the tensioning block 33. The spring holder 32 bears against the end of the tension screw 34. Referring back to FIG. 2, an appropriate amount of spring tension must be maintained to keep the roller bearings 44, 84 in contact with the bearing surfaces 22, 62. This is accomplished by spring tension afforded by assemblies 24, and the tension may be increased by turning the tension screw 34 clockwise, or decreased by turning the screw 34 counterclockwise.

Referring back to FIGS. 1, 2, and 4, the roll axis assembly 15 is attached to the pitch axis assembly 12 at right angles and, therefore, operate along perpendicular axes. Thus, the axis representing the center of rotation of the pitch axis carriage assembly 40 can only intersect with the axis representing the center of rotation of the roll axis carriage assembly 80 at a single point. A single, coincident point exists because the curves defined by the plurality of pitch axis bearing surfaces 22 and the identical curves defined by the plurality of roll axis bearing surfaces 62 possess different radii. More specifically, the curve radius defined by the pitch axis bearing surfaces 22 is larger than that of the roll axis bearing surfaces 62 because the pitch axis bearing surfaces 22 are positioned a greater distance from the single, coincident point. The curve radius defined by the pitch axis bearing surfaces 22 and that of the roll axis bearing surfaces 62 must be different in order to compensate for the physical dimensions of the various assemblies (e.g. the thickness of the roll axis base plate 60). By definition, that single, coincident point is the center of rotation of the pitch and roll mechanism 100. When positioned in the bonding head assembly, the center of the bonding surface of the workpiece (e.g. integrated circuit wafer/chip, substrate) is also located at the center of rotation of the pitch and roll mechanism 100. The mechanism 100 provides a means to adjust the angular orientation of the planar surface of the workpiece around two axes of motion without causing any amount of workpiece translation (i.e. horizontal movement) that would affect its linear alignment.

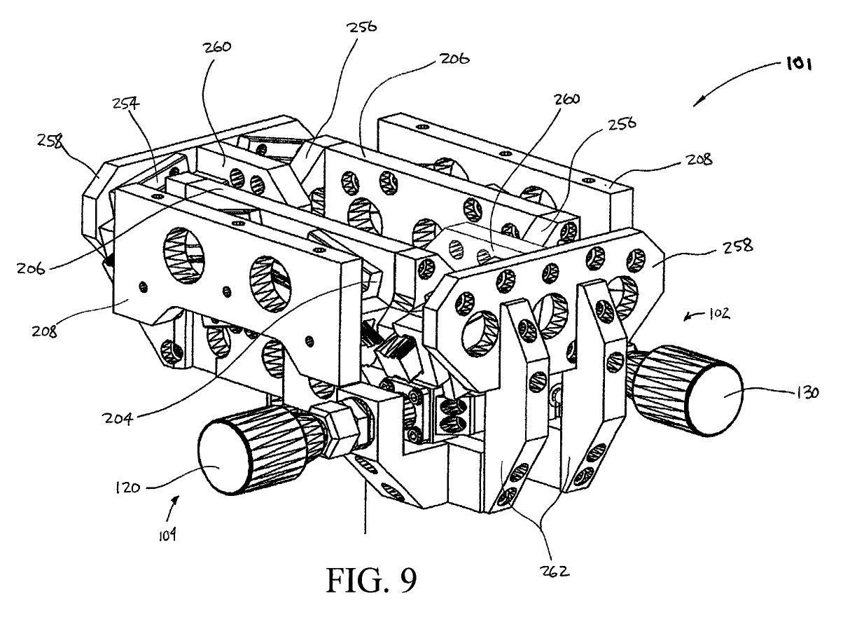

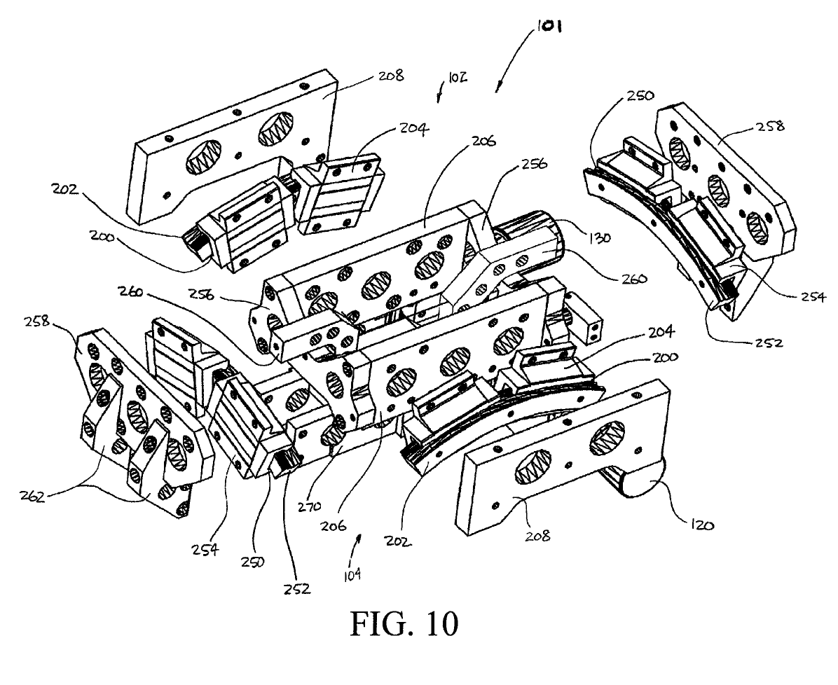

One skilled in the art would recognize that the same two axes of motion can be accomplished by alternate means without departing from the scope and spirit of the present invention. For example, FIG. 9 is a perspective view of a pitch and roll mechanism 101 according to an alternative embodiment of the present invention. FIG. 10 is an exploded perspective view of the mechanism 101 shown in FIG. 9 wherein the mechanism 101 has been rotated 90° counterclockwise (as viewed from above). This alternative embodiment 101 utilizes a plurality of commercially available, radial slide assemblies 200, 250 to achieve the same purpose. The radial slide assemblies 200, 250 take the place of the plurality of roller bearings 44, 84, the plurality of bearing surfaces 22, 62, the roller bearing shafts 46, 48, 86, 88, and the plurality of tension spring assemblies 24 (all as shown in FIGS. 2-5). Each radial slide assembly 200, 250 includes a curved rail 202, 252 (i.e. bearing surface) and two roller bearing assemblies 204, 254 which hold the respective curved rails 202, 252 captive and ride there along.

The roll axis assembly 102 of FIGS. 9 and 10 is comprised of drive mechanism 130 (see FIG. 6a), two radial slide assemblies 200 (with curved rails 202 and roller bearing assemblies 204), two inner bearing mounting plates 206, and two outer bearing mounting plates 208. The mounting plates 206, 208 may be fabricated of aluminum or the like. The curved rails 202 are fixedly attached to the inner bearing mounting plates 206. The roller bearing assemblies 204 are fixedly attached to the outer bearing mounting plates 208 and slidably interact with the curved rails 202. Rotation of the drive mechanism 130 causes the roller bearing assemblies 204 to traverse the curved rails 202 due to the pivoting connection between the drive mechanism 130 and one of the inner bearing mounting plates 206.

The pitch axis assembly 104 of FIGS. 9 and 10 is comprised of a drive mechanism 120 (see FIG. 6a), two radial slide assemblies 250 (with curved rails 252 and roller bearing assemblies 254), two inner bearing mounting plates 256, two outer bearing mounting plates 258, and two center braces 260. The mounting plates 256, 258 and center braces 260 may be fabricated of aluminum or the like. The curved rails 252 are fixedly attached to the inner bearing mounting plates 256. The roller bearing assemblies 254 are fixedly attached to the outer bearing mounting plates 258 and slidably interact with the curved rails 252. Rotation of the drive mechanism 120 causes the roller bearing assemblies 254 to traverse the curved rails 252 due to a pivoting connection between the drive mechanism 120 and one of the inner bearing mounting plates 256. The pitch axis assembly 104 is attached to the roll axis assembly 102 via a fixed connection between the pitch axis inner bearing mounting plates 256 and the roll axis inner bearing mounting plates 206.

A workpiece (not shown) is held in a chuck (also not shown) that is fixedly attached to the two chuck mounting blocks 270. The blocks 270 are fixedly attached to a plurality of connecting plates 262 and center braces 260 which are, in turn, each fixedly attached to the pitch axis outer bearing mounting plates 258. The blocks 270 and connecting plates 262 may be fabricated of aluminum or the like.

The right angle connection between the inner bearing mounting plates 206, 256 creates a configuration where the roll axis assembly and the pitch axis assembly operate along perpendicular axes. As before, the axis representing the center of rotation of the pitch axis assembly 104 can only intersect with the axis representing the center of rotation of the roll axis assembly 102 at a single point. A single, coincident point exists because the radial slide assemblies 200, 250 have curved rails 202, 252 possessing identical radii, and the rails 202, 252 are located equidistant from that coincident point. By definition, that single, coincident point is the center of rotation of the alternative pitch and roll mechanism 101. When positioned in the aformentioned chuck, the center of the bonding surface of the workpiece is also located at the center of rotation of the alternative pitch and roll mechanism 101. Consequently, the alternative pitch and roll mechanism 101 provides an equally effective means to adjust the angular orientation of the planar surface of the workpiece around two axes of motion without causing any amount of workpiece translation (i.e. horizontal movement) that would affect its linear alignment.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. An improved pitch and roll mechanism for positioning miniaturized electronic components in a bonding system, comprising:
a pitch axis assembly comprising a first pitch axis sub-assembly having a curved bearing surface and a second pitch axis sub-assembly adapted for bearing contact along the bearing surface of said first pitch axis sub-assembly and rotation relative thereto about a pitch axis of rotation;
a roll axis assembly comprising a first roll axis sub-assembly having a curved bearing surface and a second roll axis sub-assembly adapted for bearing contact along the bearing surface of said first roll axis sub-assembly and rotation relative thereto about a roll axis of rotation;
said pitch axis assembly being attached to said roll axis assembly and oriented relative thereto such that pitch axis of rotation is orthogonal to said roll axis of rotation.

2. The improved pitch and roll mechanism according to claim 1, wherein said pitch axis assembly is mounted at a right angle relative to said roll axis assembly.

3. The improved pitch and roll mechanism according to claim 1, wherein said pitch axis assembly further comprises a pitch axis drive mechanism for rotating said first pitch axis subassembly relative to said second pitch axis sub-assembly, and said roll axis assembly further comprises a roll axis drive assembly for rotating said first roll axis sub-assembly relative to said second roll axis sub-assembly, whereby said pitch axis assembly and said roll axis assembly may be operated independently or simultaneously.

4. The improved pitch and roll mechanism according to claim 2, wherein an axis of rotation of the pitch axis assembly and an axis of rotation of the roll axis assembly intersect at a single point, said single point representing a center of rotation of the pitch and roll mechanism.

5. The improved pitch and roll mechanism according to claim 1, wherein said first pitch axis sub-assembly is formed with a bearing surface having a circular curvature.

6. The improved pitch and roll mechanism according to claim 1, wherein said second pitch axis sub-assembly further comprises at least one roller bearing in operative contact with the curved bearing surface of said first pitch axis sub-assembly.

7. The improved pitch and roll mechanism according to claim 1, wherein said first pitch axis sub-assembly further comprises a plurality of discrete bearing surfaces aligned to collectively definine a circular curvature.

8. The improved pitch and roll mechanism according to claim 7, wherein said second pitch axis sub-assembly further comprises a plurality of roller bearings each in operative contact with a corresponding discrete bearing surface of said first pitch axis sub-assembly.

9. The improved pitch and roll mechanism according to claim 2, wherein said pitch axis drive assembly further comprises an external rotational drive.

10. The improved pitch and roll mechanism according to claim 9, wherein said external rotational drive is bi-directional.

11. The improved pitch and roll mechanism according to claim 10, wherein bi-directional rotation of said external pitch axis drive causes said second pitch axis sub-assembly to ride along the curved bearing surfaces of said first pitch axis sub-assembly, thereby changing relative angular orientation of the first and second pitch axis sub-assemblies.

12. The improved pitch and roll mechanism according to claim 1, wherein said first roll axis sub-assembly is formed with a bearing surface having a circular curvature.

13. The improved pitch and roll mechanism according to claim 12, wherein said second roll axis sub-assembly further comprises at least one roller bearing in operative contact with the curved bearing surface of said first roll axis sub-assembly.

14. The improved pitch and roll mechanism according to claim 13, wherein said first roll axis sub-assembly further comprises a plurality of discrete bearing surfaces aligned to collectively define a circular curvature.

15. The improved pitch and roll mechanism according to claim 14, wherein said second roll axis sub-assembly further comprises a plurality of roller bearings each in operative contact with a corresponding discrete bearing surface of said first roll axis sub-assembly.

16. The improved pitch and roll mechanism according to claim 15, wherein said roll axis drive assembly further comprises an external rotational drive.

17. The improved pitch and roll mechanism according to claim 16, wherein said external rotational drive is bi-directional.

18. The improved pitch and roll mechanism according to claim 17, wherein bi-directional rotation of said external roll axis drive causes said second roll axis sub-assembly to ride along the curved bearing surfaces of said first roll axis sub-assembly, thereby changing relative angular orientation of the first and second roll axis sub-assemblies.

19. A method of positioning miniaturized electronic components utilizing an improved pitch and roll mechanism, comprising the steps of:
changing the angular orientation of a component with respect to a pitch axis of rotation; and
changing the angular orientation of said component with respect to a roll axis of rotation;
said pitch axis of rotation and said roll axis of rotation being oriented orthogonally to one another.

20. The method of positioning a workpiece in a flip chip bonding system according to claim 19, wherein said pitch axis of rotation and said roll axis of rotation intersect at a single point.
